(19) United States
(12) Patent Application Publication
(10) Pub. No.: US 2010/0290616 A1
(43) Pub. Date: Nov. 18, 2010

(54) TELEPHONE WITH STATE DETECTION USING INFRARED

(75) Inventor: JIN-JYE CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/718,080

(22) Filed: Mar. 5, 2010

(30) Foreign Application Priority Data
May 12, 2009 (CN) 200920303068.1

(51) Int. Cl. H04M 1/00

(52) U.S. Cl. 379/419

(57) ABSTRACT

A telephone includes a phone-set and a handset. The phone-set includes an infrared emitter and a processor driving the infrared emitter to emit infrared light. When the telephone is on-hook, the infrared light is reflected to the handset. The handset reflects the infrared light back to the phone-set, and the infrared light reflected back from the handset is eventually received by an infrared detector of the phone-set. Thus, the processor determines on/off-hook states of the telephone according to reception of the infrared light by the infrared detector.

### BACKGROUND

1. Technical Field

The disclosure relates to telecommunications, and particularly to a telephone.

2. Description of Related Art

Telecom systems require determination of a telephone's on/off-hook states to properly process communications. Some telephones incorporate mechanical detectors to determine on/off-hook states, which waste manpower and time during assembly and testing. Further, sensitivity of such detectors diminishes with use, negatively affecting performance of the telephones.

### BRIEF DESCRIPTION OF THE DRAWINGS

FIG. 1 is a schematic diagram of an embodiment of a telephone as disclosed.

FIGS. 2 and 3 are schematic diagrams illustrating infrared reflection in the telephone of FIG. 1.

### DETAILED DESCRIPTION

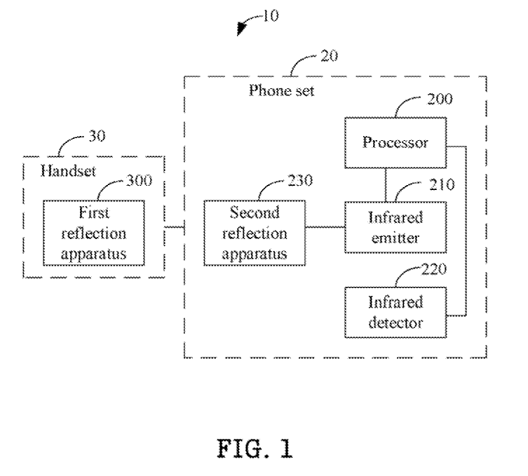

FIG. 1 is a schematic diagram of an embodiment of a telephone 10 as disclosed. The telephone 10 includes a phone-set 20 and a handset 30 paired with the phone-set 20. In the embodiment, the handset 30 is connected to the phone-set 20 by a cable. When the handset 30 is seated on the phone-set 20, the telephone 10 is on-hook. When the handset 30 is separated from the phone-set 20, the telephone 10 is off-hook. The handset 30 includes a first reflection apparatus 300 to reflect infrared light.

The phone-set 20 includes a processor 200, an infrared emitter 210, an infrared detector 220, and a second reflection apparatus 230. The processor 200 directs the infrared emitter 210 to emit infrared light. In one embodiment, the processor 200 directs the infrared emitter 210 according to a fixed frequency. The fixed frequency is set according to actual needs, for example, five seconds. That is, per five seconds, the processor 200 directs the infrared emitter 210 to emit infrared light. The second reflection apparatus 230 reflects the infrared light emitted by the infrared emitter 210.

When the handset 30 is properly seated on the phone-set 20, that is, the telephone 10 is on-hook, the infrared light emitted by the infrared emitter 210 is eventually received by the infrared detector 220 through reflection of the second reflection apparatus 230 and the first reflection apparatus 300. The processor 200 determines on/off-hook states of the telephone 10 according to whether the infrared light is received by the infrared detector 220. In one embodiment, the infrared light emitted by the infrared emitter 210 is first reflected to the first reflection apparatus 300 by the second reflection apparatus 230. Then, the first reflection apparatus 300 may reflect the infrared light back to the phone-set 20, which is received by the infrared detector 220. In one embodiment, the processor 200 determines the on/off-hook states of the telephone 20 according to a same frequency as the fixed frequency that the processor 200 directs the infrared emitter 210.

In one embodiment, the first reflection apparatus 300 and the second reflection apparatus 230 have reflection ability, for example, being reflection boards. Angles of the first reflection apparatus 300 and the second reflection apparatus 230 are set, such as, for example, 45°, according to photics principles, and may be variable according to different needs. Thus, when the handset 30 is properly seated on the phone-set 20, the second reflection apparatus 230 reflects the infrared light emitted by the infrared emitter 210 to the first reflection apparatus 300. The first reflection apparatus 300 reflects the infrared light back to the phone-set 20, and the infrared detector 220 receives the infrared light. Then the processor 200 determines the telephone 10 is on-hook according to reception of the infrared light by the infrared detector 220. In one embodiment, infrared light may penetrate the phone-set 20 and the handset 30.

When the handset 30 is separated from the phone-set 20, no infrared light is reflected to the handset 30 from the second reflection apparatus 230, or, in turn, to infrared detector 220, and the processor 200 determines the telephone 10 is off-hook.

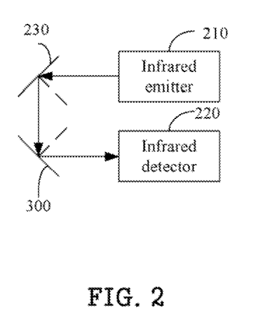

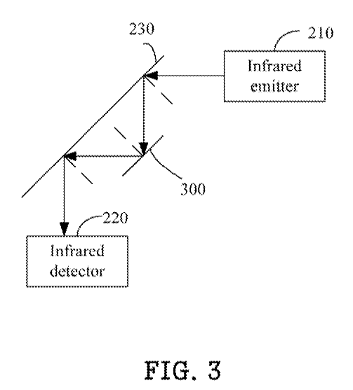

In one embodiment, when the telephone 10 is on-hook, the first reflection apparatus 300 directly reflects the infrared light to the infrared detector 220 of the phone-set 20 as shown in FIG. 2. It may be understood that arrangements and reflection paths of the first reflection apparatus 300 and the second reflection apparatus 230 may be variable. For example, as shown in FIG. 3, the first reflection apparatus 300 reflects the infrared light back to the second reflection apparatus 230, and the second reflection apparatus 230 reflects the infrared light to the infrared detector 220. In this embodiment, the second reflection apparatus 230 may be larger than the first reflection apparatus 300.

In one embodiment, the processor 200 directs the infrared emitter 210 to emit infrared light including an identification code to avoid confusion with other infrared light, and determines the on/off-hook states of the telephone 10 according to reception of the infrared light including the identification code by the infrared detector 220. Thus, the processor 200 can make precise determination.

The telephone 10 makes determination of on/off-hook states utilizing infrared light, which simplifies circuitry, assembly, and testing of the telephone 10 and decreases costs. The telephone 10 also retains sensitivity with use, which extends lifetime thereof.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A telephone, comprising:
a handset comprising a first reflection apparatus; and
a phone-set paired with the handset, comprising:
an infrared emitter to emit infrared light;
a processor to direct the infrared emitter to emit the infrared light;
a second reflection apparatus to reflect the infrared light emitted by the infrared emitter; and
an infrared detector;
wherein when the handset is seated on the phone-set, the infrared light emitted by the infrared emitter is reflected by the second reflection apparatus and the first reflection apparatus and received by the infrared detector, and the processor determines on/off-hook states of the telephone accordingly.

2. The telephone of claim 1, wherein the first reflection apparatus directly reflects the infrared light reflected by the second reflection apparatus to the infrared detector when the telephone is on-hook.

3. The telephone of claim 1, wherein the first reflection apparatus reflects the infrared light reflected by the second reflection apparatus to the second reflection apparatus, and then the second reflection apparatus reflects the infrared light reflected by the first reflection apparatus to the infrared detector when the telephone is on-hook.

4. The telephone of claim 1, wherein the processor directs the infrared emitter according to a fixed frequency.

5. The telephone of claim 4, wherein the processor determines the on/off-hook states of the telephone according to a same frequency as the fixed frequency that the processor directs the infrared emitter.

6. The telephone of claim 1, wherein the infrared light emitted by the infrared emitter includes an identification code.

7. The telephone of claim 6, wherein the processor determines the on/off-hook states of the telephone according to whether the infrared light including the identification code is received by the infrared detector.
